(19) United States
(12) Patent Application Publication
(10) Pub. No.: US 2013/0293594 A1
(43) Pub. Date: Nov. 7, 2013

(54) APPARATUS AND METHOD FOR DISPLAYING IMAGE, AND APPARATUS AND METHOD FOR DRIVING LIGHT-EMITTING DEVICE

(71) Applicant: SAMSUNG ELECTRONICS CO., LTD., Suwon-si (KR)

(72) Inventor: Jeong-il KANG, Yongin-si (KR)

(73) Assignee: SAMSUNG ELECTRONICS CO., LTD., Suwon-si (KR)

(21) Appl. No.: 13/770,192

(22) Filed: Feb. 19, 2013

(30) Foreign Application Priority Data
May 4, 2012 (KR) 10-2012-0047729

(51) Int. Cl. G09G 5/10

(52) U.S. Cl. CPC G09G 5/10
USPC 345/690

(57) ABSTRACT

An apparatus and a method for displaying an image, and an apparatus and a method for driving a light-emitting device are provided. The apparatus includes: a transient state information provider which generates and outputs image data of an input image and a timing signal for displaying the image data on a screen, and provides a transient state signal in an abnormal operation of a power source or the image input into the apparatus; a display panel which receives the image data and the timing signal and displays the image on the screen by using the image data and the timing signal; and a backlight unit (BLU) which generates a control signal for controlling a light-emitting device providing light to the display panel and adjusts a characteristic of the control signal corresponding to an abnormal operation section of the abnormal operation to be linearly changed by using the transient state signal provided from the transient state information provider in order to control the light-emitting device.

### CROSS-REFERENCE TO RELATED APPLICATION

This application claims priority from 35 U.S.C. §119 from Korean Patent Application No. 10-2012-0047729, filed on May 4, 2012, in the Korean Intellectual Property Office, the disclosure of which is incorporated herein by reference in its entirety.

### BACKGROUND

1. Field

Apparatuses and methods consisted with exemplary embodiments relate to an apparatus and a method for displaying an image, and an apparatus and a method for driving a light-emitting device, and more particularly, to an apparatus and a method for displaying an image, by which a transient phenomenon, such as an inrush current, an over-shoot, and a under-shoot, occurring in initial driving of or during driving of an image display apparatus having a light-emitting diode (LED) backlight is reduced, and an apparatus and a method for driving a light-emitting device.

2. Description of the Related Art

In general, an image display apparatus is used to display an image signal input from a video card or the like. The image display apparatus may be classified into a light-emitting type and a light-receiving type. For example, an image display apparatus, such as a cathode-ray tube or a plasma display panel (PDP), belongs to a light-emitting type and self-emits light to display an image. However, a liquid crystal display is a light-receiving apparatus which injects a liquid crystal having an intermediate property of solid and liquid between two thin glass substrates to change an arrangement of liquid crystal molecules when supplying power, in order to generate light and shade, and display an image. Therefore, the light-receiving apparatus may not be used without a backlight source and thus requires a backlight lamp which is a surface light source type.

An LED may be used as the backlight lamp, and a plurality of LEDs may be arranged at an edge of a panel or on a back surface of the panel in order to provide light in a surface light source form. In general, the LEDs arranged at the edge of the panel are referred to as edge type LEDs, and the LEDs arranged on the back surface of the panel are referred to as direct type LEDs.

Also, the image display apparatus includes a lamp driver which drives the backlight lamp. The lamp driver may include a switching type power circuit which turns on/off the backlight lamp.

However, an inrush current is generated in initial driving or during driving of the image display apparatus, or a transient phenomenon coming out of a normal state, such as over-shoot and under-shoot, occurs. The capacities of circuit elements may be designed in order to endure the transient phenomenon. In this case, manufacturing cost increases.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

The exemplary embodiments provide an apparatus and a method for displaying an image by which manufacturing coast is reduced, and a transient phenomenon of the apparatus is improved, and also provide an apparatus and a method for driving a light-emitting device.

According to an aspect of the exemplary embodiments, there is provided an apparatus for displaying an image. The apparatus may include: a transient state information provider configured to generate and output image data of an input image and a timing signal for displaying the image data on a screen, the transient state information provider being further configured to provide a transient state signal in an abnormal operation of a power source and the image input into the apparatus; a display panel which receives the image data and the timing signal and displays the image on the screen by using the image data and the timing signal; and a backlight unit (BLU) which generates a control signal for controlling a light-emitting device providing light to the display panel, and the BLU adjusts a characteristic of the control signal corresponding to an abnormal operation section of the abnormal operation to be changed by using the transient state signal provided from the transient state information provider in order to control the light-emitting device.

The transient state information provider may include a power supply voltage generator which provides a power supply voltage as the transient state signal in initial driving of the apparatus.

The transient state information provider may include a dimming signal generator which generates and provides a dimming signal indicating brightness of a unit frame image as the transient state signal.

If the dimming signal indicating the brightness of the unit frame image is used, the BLU may determine the abnormal operation when brightnesses of a plurality of unit frame images are equally maintained.

The BLU may implement pulse width modulation (PWM)-control of the light-emitting device and adjust pulses in a section in which the brightnesses of the plurality of unit frame images are equally maintained to have different pulse widths in order to adjust the characteristic of the control signal.

According to another aspect of the exemplary embodiments, there is provided an apparatus for driving a light-emitting device. The apparatus may include: a modulation signal generator configured to generate and output a control signal for controlling the light-emitting device, change a characteristic of the control signal corresponding to an abnormal operation section in an abnormal operation of a power source or an image input into an image display apparatus, and output the changed control signal; a compensator configured to provide a comparison result by comparing a detection signal of the light-emitting device with a reference signal, provide the comparison result to the modulation signal generator, and convert the control signal according to the comparison result to compensate the light-emitting device; and a transient state determiner configured to receive a transient state signal for acknowledging the abnormal operation of the image display apparatus and controls the characteristic of the control signal to be changed by using the transient state signal.

The apparatus may further include a stabilizer which is installed between the modulation signal generator and the compensator; the stabilizer stabilizes the comparison result, and provides the stabilized comparison result to the modulation signal generator.

The transient state determiner may include: a switch which is connected between an end of the modulation signal generator to which the comparison result is applied and a ground, and pulls the comparison result to the ground; and a soft start part which determines the abnormal operation of the image display apparatus by using the transient state signal and changes an impedance characteristic of the switching unit according to a determination result to change the characteristic of the control signal.

The soft start part may control the switching unit so that pulse signals corresponding to the abnormal operation section have different pulse widths, in order to change the characteristic of the control signal.

The soft start part may control the switching unit by using the power supply voltage provided at an initial driving of the image display apparatus.

The apparatus may further include a latch which receives a dimming signal for indicating brightness of a unit frame image input into the image display apparatus as the transient state signal and provides a processing result of the dimming signal to the transient state determiner.

The apparatus may further include a timer which counts whether brightnesses of a plurality of unit frame images are equally maintained, by using the transient state signal and, if a counted result exceeds a value, resets the latch.

The apparatus may further include a reset driver which, when brightnesses of a plurality of unit frame images are equally maintained and the light-emitting device exceeds a value, resets the latch.

The reset driver may include: a current source unit which is connected to the power supply voltage to perform a role of a current source; a switch which, when a brightness is in a dim state, is connected to the current source unit, and when the brightness is in other states except the dim state, is grounded; and a charger which comprises a terminal which is connected to the latch and the switching unit and another terminal which is grounded, and, when the switch is connected to the current source unit, charges a current provided from the current source unit and outputs the charged value to the latch to perform the resetting.

The charger may include a capacitor. The resetting of the latch may be determined based on a capacitance of the capacitor which determines whether the light-emitting device exceeds the value.

According to another aspect of the exemplary embodiments, there is provided a method of displaying an image. The method may include: generating and outputting image data of an input image and a timing signal for displaying the image data on a screen, and providing at least one from among a transient state signal in an abnormal operation of a power source and the image input into an image display apparatus; receiving the image data and the timing signal and displaying the image on a screen of a display panel by using the image data and the timing signal; and generating a control signal for controlling a light-emitting device providing light to the display panel and adjusting a characteristic of the control signal corresponding to an abnormal operation section in the abnormal operation to be changed by using the transient state signal in order to control the light-emitting device.

A power supply voltage may be provided as the transient state signal at an initial driving of the image display apparatus or a dimming signal indicating brightness of a unit frame image may be generated and provided.

The control of the light-emitting device may include: if the dimming signal indicating the brightness of the unit frame image is used, determining the abnormal operation when brightnesses of a plurality of unit frame images are equally maintained.

The control of the light-emitting device may include: PWM-controlling the light-emitting device and adjusting pulses of a section in which the brightnesses are equally maintained to have different pulse widths in order to adjust the characteristic of the control signal.

According to another aspect of the exemplary embodiments, there is provided a method of driving a light-emitting device. The method may include: generating and outputting a control signal for controlling the light-emitting device through a modulation signal generator, and changing and outputting a characteristic of the control signal corresponding to an abnormal operation section in an abnormal operation of a power source or an image input into an image display apparatus; comparing a detection signal of the light-emitting device with a preset reference signal through a compensator, providing, by a compensator, a comparison result to the modulation signal generator, and converting the control signal according to the comparison result to compensate the light-emitting device; and receiving, by a transient state determiner, a transient state signal for acknowledging the abnormal operation of the image display apparatus and controlling the characteristic of the control signal to be changed by using the transient state signal.

The method may further include: stabilizing the comparison result through a stabilizer installed between the modulation signal generator and the compensator, and providing the stabilized comparison result to the modulation signal generator through the stabilizer.

The control of the characteristic of the controlling signal to be changed may include: pulling the comparison result to a ground through a switching unit connected between an end of the modulation signal generator to which the comparison result is applied and the ground; and determining the abnormal operation of the image display apparatus by using the transient state signal and changing a characteristic of an impedance of the switching unit according to a determination result to change the characteristic of the control signal.

The switching unit may be controlled so that pulse signals corresponding to the abnormal operation section have different pulse widths, in order to change the characteristic of the control signal.

The switching unit may be controlled by using a power supply voltage provided at an initial driving of the image display apparatus in order to change the characteristic of the control signal.

The method may further include: receiving a dimming signal indicating brightness of a unit frame image input into the image display apparatus as the transient state signal through a latch and providing a processing result of the dimming signal to the transient state determiner through the latch.

The method may further include: counting whether brightnesses of a plurality of unit frame images are equally maintained, by using the transient state signal, and if the counting result exceeds a value, resetting the latch.

The method may further include: if brightnesses of a plurality of unit frame images are equally maintained, and the light-emitting device exceeds a value, resetting the latch.

The resetting of the latch may include: if a brightness is in a dim state, performing a connection to a current source unit to receive a current, and if a brightness is in other states except the dim state, performing grounding; and if the connection to the current source unit is performed, charging the current provided from the current source unit and providing a charged value to reset the latch.

The charging may be performed by a capacitor, and the resetting may be determined based on a capacitance of the capacitor which determines whether the light-emitting device exceeds the value.

### BRIEF DESCRIPTION OF THE DRAWINGS

The above and/or other aspects will be more apparent by describing certain exemplary embodiments with reference to the accompanying drawings, in which:

FIG. 1 is a block diagram illustrating a structure of an image display apparatus according to an exemplary embodiment;

FIG. 2 is a block diagram illustrating a structure of an image display apparatus according to another exemplary embodiment;

FIG. 3 is a circuit diagram of a lamp driver and a backlight unit (BLU) of FIG. 1;

FIG. 4 is a circuit diagram of a controller of FIG. 3 according to an exemplary embodiment;

FIG. 5 is a circuit diagram of a soft start block of FIG. 4;

FIG. 6 is a view illustrating soft start operation waveforms;

FIGS. 7C and 7D are views illustrating output waveforms in a soft start operation of an exemplary embodiment, and FIGS. 7A and 7B are views illustrating output waveforms in a conventional soft start operation;

FIG. 8 is a circuit diagram of the controller of FIG. 3 according to another exemplary embodiment;

FIG. 9 is a circuit diagram of the controller of FIG. 3 according to another exemplary embodiment;

FIG. 10 is a circuit diagram of the controller of FIG. 3 according to another exemplary embodiment;

FIG. 11 is a flowchart illustrating a method of displaying an image according to an exemplary embodiment ; and

FIG. 12 is a flowchart illustrating a method of driving a light-emitting device according to an exemplary embodiment.

### DETAILED DESCRIPTION OF THE EXEMPLARY EMBODIMENTS

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail

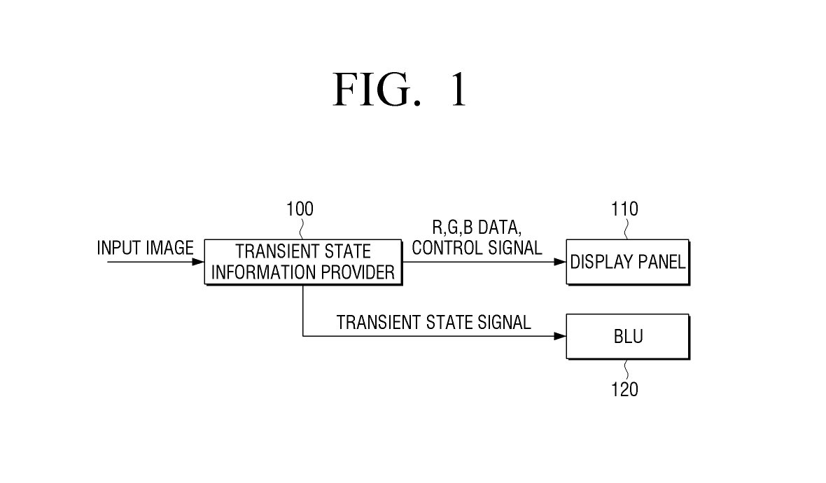

FIG. 1 is a block diagram illustrating a structure of an image display apparatus according to an exemplary embodiment.

Referring to FIG. 1, the image display apparatus according to the present exemplary embodiment includes a transient state information provider 100, a display panel 110, and a part or a whole of a backlight unit (BLU) 120. Here, the terminology of a ‘part or the whole’ of the BLU 120 denotes that the transient state information provider 100 may be integrated with the BLU 120. For descriptive convenience, the BLU 120 is considered as a ‘whole’ entity herein some of the exemplary embodiments.

The transient state information provider 100 may provide a generated power supply voltage Vcc to the BLU 120 in initial driving (or operating) of the image display apparatus or may generate image information from an input image, i.e., a dimming signal, and provide the image information to the BLU 120. Here, the dimming signal is a signal indicating brightness information about an input image of a unit frame, i.e., a signal indicating a dim degree of the corresponding unit frame.

The transient state information provider 100 may convert R, G, and B image data input from an external source so that the R, G, and B image data is appropriate for a resolution of the image display apparatus, and may output the converted R, G, and B image data. For example, the transient state information provider 100 converts 8-bit R, G, and B video data into 6-bit data and provides the 6-bit data to the display panel 110. In this process, the transient state information provider 100 may generate a timing signal which is to control timing of a gate/source driver formed on the display panel 110.

The transient state information provider 100 may generate control signals, such as a clock signal DCLK, and vertical and horizontal sync signals Vsync and Hsync, appropriate for the resolution of the image display apparatus and provide the control signals to the BLU 120. Therefore, the BLU 120 may synchronize with the input image and thus may turn on/off a light-emitting device and a backlight.

The display panel 110 may include first and second substrates and a liquid crystal layer interposed between the first and second substrates. The first substrate includes a plurality of gate lines GL1 through GLn and a plurality of data lines DL1 through DLn which cross one another to define pixel areas. Pixel electrodes are formed in the pixel areas in which the gate lines GL1 through GLn cross the data lines DL1 through DLn. Thin film transistors (TFTs) are formed in areas of the pixel areas, in more detail, at corners of the pixel areas. When turning on the TFTs, a liquid crystal is twisted by a difference between voltages applied to a pixel electrode of the first substrate and a common electrode of the second substrate so as to transmit light provided from the BLU 120.

The display panel 110 may include a gate driver and a source driver formed at an edge of a display area on which an image is realized. In this case, the display panel 110 operates the gate driver and the source driver according to the timing control signal provided from the transient state information provider 100. Therefore, the display panel 110 displays the R, G, and B data provided from the transient state information provider 100 on the display area through the source driver to realize an image. Other detailed contents will be described later.

The BLU 120 may include a lamp driver which processes the power supply voltage Vcc or the dimming signal provided from the transient state information provider 100 and a backlight unit which provides backlight under control of the lamp driver. Here, the backlight unit includes light-emitting devices such as light-emitting diodes (LEDs) and provides the backlight to the display panel 110 according to a command of the lamp driver. The lamp driver drives the backlight unit according to a command of the transient state information provider 100 and feedback-controls the backlight unit.

According to an exemplary embodiment, if the BLU 120 receives the power supply voltage Vcc from the transient state information provider 100, the BLU 120 forces the backlight unit not to be in a transient state by using the power supply voltage Vcc. In other words, a system may instantaneously maintain an instable state in the initial operating of the image display apparatus but may synchronize with the image display apparatus in the initial operating of the image display apparatus to control the backlight unit in the present exemplary embodiment. Also, a time difference may occur until an LED of the backlight unit operates after the power supply voltage Vcc is applied. In this case, a transient state may be prevented by using the dimming signal provided from the transient state information provider 100. More detail will be provided below.

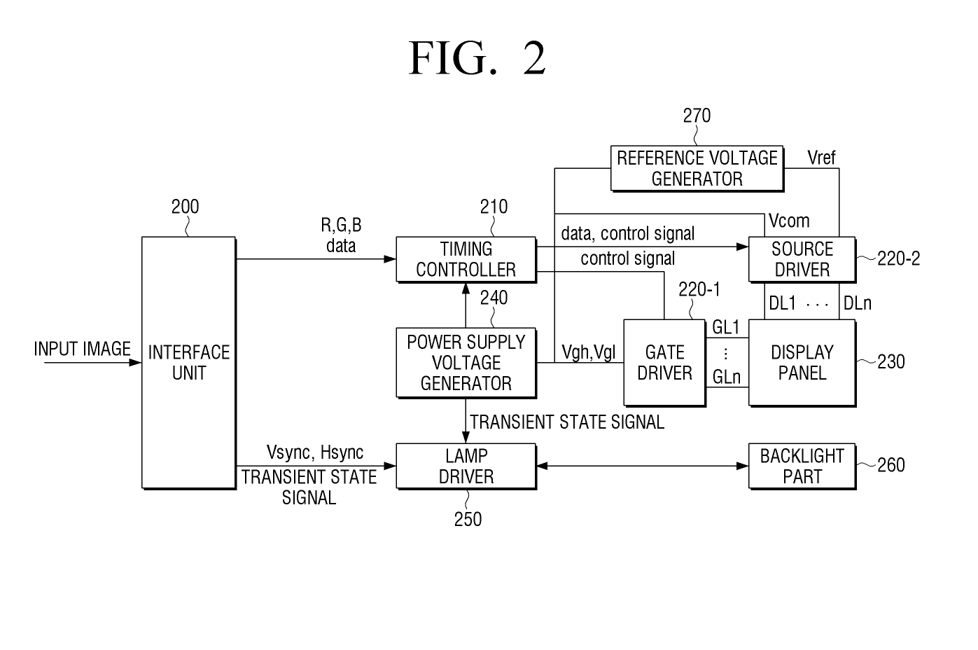

FIG. 2 is a block diagram illustrating a structure of the image display apparatus according to another exemplary embodiment.

Referring to FIG. 2, the image display apparatus includes an interface unit 200, a timing controller 210, a gate driver 220-1, a source driver 220-2, a display panel 230, a power supply voltage generator 240, a lamp driver 250, a backlight unit 260, and a part or a whole of a reference voltage generator 270.

The recitation of ‘the part or the whole’ denotes that some elements may be integrated with one another like the lamp driver 250 and the backlight unit 260 are integrated into a BLU.

The interface unit 200 may be an image board such as a graphic card, converts image data input from an external source so that the image data is appropriate for a resolution of the image display apparatus, and outputs the converted image data. Here, the image data may be 8-bit R, G, and B image data, and the interface unit 200 generates control signals, such as a clock signal DCLK, and vertical and horizontal sync signals Vsync and Hsync, appropriate for the resolution of the image display apparatus. The interface unit 200 provides the image data to the timing controller 210 and provides the vertical/horizontal sync signal Vsync/Hsync to the lamp driver 250. Therefore, the interface unit 200 synchronizes with the display panel 230 when an image is realized on the display panel 230, in order to turn on and off the backlight unit 260.

The interface unit 200 may also include an image analyzer (not shown). Here, the image analyzer may analyze an input image to determine brightness. The image analyzer may generate a dimming signal as to brightness of a continuous unit frame, e.g., a dim degree, and provide the dimming signal as a transient state signal to the lamp driver 250. The image analyzer may be included in the interface unit 200 or may be separated from the interface unit 200 but is not limited thereto.

The timing controller 210 provides the image data provided from the interface unit 200 or the image analyzer to the source driver 220-2 and controls the image data output from the source driver 220-2 by using a timing signal in order to sequentially realize unit frame images on the display panel 230. The timing controller 210 also controls the gate driver 220-1 to provide a gate on/off voltage, which is provided from the power supply voltage generator 240, to the display panel 230 every horizontal line. For example, if a gate voltage is applied to a first gate line GL1, the timing controller 210 controls the source driver 220-2 to apply corresponding image data onto a first horizontal line. Also, the timing controller 210 turns on a second gate line GL2 and turns off the first gate line GL1 to apply image data corresponding to a second horizontal line from the source driver 220-2 to the display panel 230. A unit frame image is displayed on a whole screen of the display panel 230 according to this method.

The gate driver 220-1 receives a gate on/off voltage Vgh/Vgl from the power supply voltage generator 240 and applies the gate on/off voltage Vgh/Vgl to the display panel 230 under control of the timing controller 210. The gate on voltage Vgh is sequentially provided from the first gate line GL1 to an nth gate line GLn when an image is realized on the display panel 230.

The source driver 220-2 converts serial image data provided from the timing controller 210 into parallel image data and converts digital data into an analog voltage in order to simultaneously and sequentially provide image data corresponding to one horizontal line to the display panel 230. The source driver 220-2 receives a common voltage Vcom from the power supply voltage generator 240 and a reference voltage Vref (or a gamma voltage) from the reference voltage generator 270. Here, the common voltage Vcom is provided to a common electrode of the display panel 230, and the reference voltage Vref is provided to a digital-to-analog converter (DAC) of the source driver 220-2 and is used to represent gradations of a color image. In other words, the image data provided from the timing controller 210 may be provided to the DAC, and digital information of video data provided to the DAC is converted into an analog voltage for representing gradations of colors and then provided to the display panel 230.

Descriptions of the display panel 230 are the same as those of the display panel 110 of the previous exemplary embodiment and thus will be omitted herein. However, if the display panel 230 is formed as a self-emission display panel including an organic light-emitting diode (OLED), etc., the display panel 230 may include the backlight unit 260.

The power supply voltage generator 240 receives a commercial voltage, i.e., an alternating current (AC) voltage of 110V or 220V, from an external source, and generates and outputs direct current (DC) voltages having various levels. For example, the power supply voltage generator 240 may generate a DC voltage of 15V as the gate on voltage Vgh and provide the DC voltage of 15V to the gate driver 220-1. Also, the power supply voltage generator 240 may generate a DC voltage of 24V as a power supply voltage Vcc and provide the DC voltage of 24V to the lamp driver 250. The power supply voltage generator 240 may generate a DC voltage of 12V and provide the DC voltage of 12V to the timing controller 210.

The lamp driver 250 converts a voltage provided from the power supply voltage generator 240 and provides the converted voltage to the backlight unit 260. Here, the conversion means that a level of an analog DC voltage is converted or pulse width modulation driving is performed with respect to the analog DC voltage. Also, the lamp driver 250 may simultaneously or separately drive R, G, and B LEDs constituting the backlight unit 260. The lamp driver 250 may include a feedback circuit which feedback-controls a driving current of the R, G, and B LEDs to uniformly emit light from the R, G, and B LEDs of the backlight unit 260. The feedback circuit may be referred to as a switching power circuit. The feedback circuit will be described in detail later.

According to an exemplary embodiment, the lamp driver 250 forces light-emitting devices of the backlight unit 260 not to be in transient states by using the power supply voltage Vcc provided from the power supply voltage generator 240 in initial driving of a system, i.e., the image display apparatus. For this purpose, the lamp driver 250 adjusts a characteristic of a signal (or a control signal) corresponding to a predetermined section in which the system is initially driven. For example, the light-emitting devices of the backlight unit 260 may be PWM-controlled by the lamp driver 250. Also, the lamp driver 250 may adjust a characteristic of a signal so that pulses corresponding to a transient state occurring section have different widths. Here, the pulse widths of the pulses may linearly increase with respect to time t.

Although the system is not initially driven, the lamp driver 250 may adjust the characteristic of the signal, which is to be applied to the light-emitting devices, according to the dimming signal provided from the interface unit 200. In detail, the lamp driver 250 may receive the dimming signal related to a unit frame image input into the interface unit 200. Here, the lamp driver 250 may synchronize with an initial dimming signal to adjust the characteristic of the signal. Also, when brightnesses of a series of unit frame images, i.e., dim states, continue, the lamp driver 250 may re-adjust the characteristic of the signal. The re-adjustment of the characteristic of the signal may include initializing.

The backlight unit 260 includes the R, G, and B LEDs. For example, the backlight unit 260 may be a direct type in which the R, G, and B LEDs are arranged at a whole lower end of the display panel 230 or an edge type in which the R, G, and B LEDs are arranged at an edge of the display panel 230. In other words, the backlight unit 260 may be any type. However, under control of the lamp driver 250, the backlight unit 260 according to the present exemplary embodiment may simultaneously turn on and off the light-emitting devices or may divide the light-emitting devices into blocks and separately turn on and off the blocks. Also, a plurality of LEDs may be connected to one another in series or in parallel, i.e., in various forms.

The reference voltage generator 270 may be referred to as a gamma voltage generator. If the reference voltage generator 270 receives a DC voltage of 10V from the power supply voltage generator 240, the reference voltage generator 270 may divide the DC voltage into a plurality of voltages through a divider resistor and provide the plurality of voltages to the source driver 220-2. Therefore, the source driver 220-2 may sub-divide the plurality of voltages to represent 256 gradations of R, G, and B data.

According to the above-described structure, when it is determined that a transient state may occur even in initial driving of the image display apparatus or even during driving of the image display apparatus, the image display apparatus according to the present exemplary embodiment may prevent an abnormal operation, i.e., a transient state operation, thereof by using a power supply voltage or a dimming signal as a transient state signal.

FIG. 3 is a circuit diagram of the lamp driver 250 and the backlight unit 260 of FIG. 2.

Referring to FIG. 3 along with FIG. 2, the lamp driver 250 according to the present exemplary embodiment includes a controller 300 and peripheral circuits installed around the controller 300. Here, the peripheral circuits include a switching element Q_{A}, an inductor L_{A}, a diode D_{A}, a capacitor C_{A}, and a part or a whole of a resistor R_{A}.

The inductor L_{A} may be provided with the power supply voltage Vcc as an input voltage V_{IN} from the power supply voltage generator 240 of FIG. 2. Another terminal of the inductor L_{A} is connected to an anode terminal of the diode D_{A} and a drain terminal of the switching element Q_{A}.

A gate terminal of the switching element Q_{A} is connected to an output terminal of the controller 300, and a source terminal of the switching element is commonly connected to other terminals of the capacitor C_{A} and the resistor R_{A} to be grounded.

A cathode terminal of the diode D_{A} is connected to a terminal of the capacitor C_{A} and an anode terminal of the light-emitting device of the backlight unit 260 of FIG. 2, i.e., the LED.

A terminal of the resistor R_{A} is connected to a cathode terminal of the light-emitting device and to an input terminal of the controller 300, i.e., a feedback terminal. Here, the input terminal receives a feedback signal of the resistor R_{A} or the light-emitting device.

The controller 300 receives a signal Iref preset by a user, compares the signal Iref with a feedback signal Io to generate a comparison result, and outputs the comparison result to the gate terminal of the switching element Q_{A} to drive the switching element Q_{A}. Here, the controller 300 provides a PWM control signal as the comparison result to PWM-control the switching element Q_{A}. The light-emitting device may provide uniform light according to the PWM-control.

The controller 300 receives a transient state signal from an external source to adjust a signal characteristic in a particular section indicating a transient state even in initial driving of the image display apparatus or even during driving of the display apparatus, in more detail, even in or during driving of the light-emitting device in order to control the switching element Q_{A}. This will be continuously described.

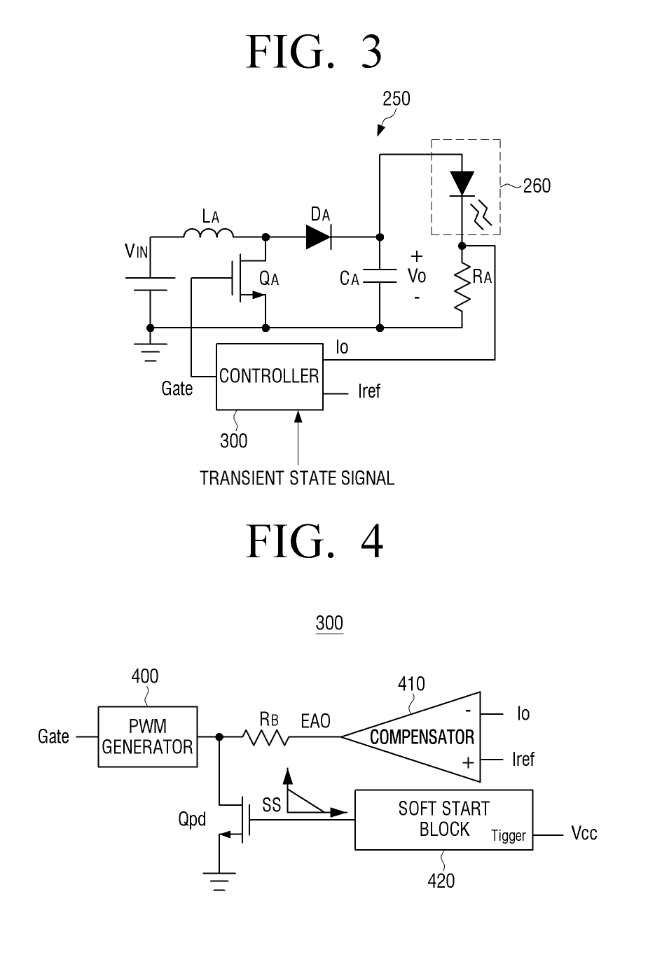

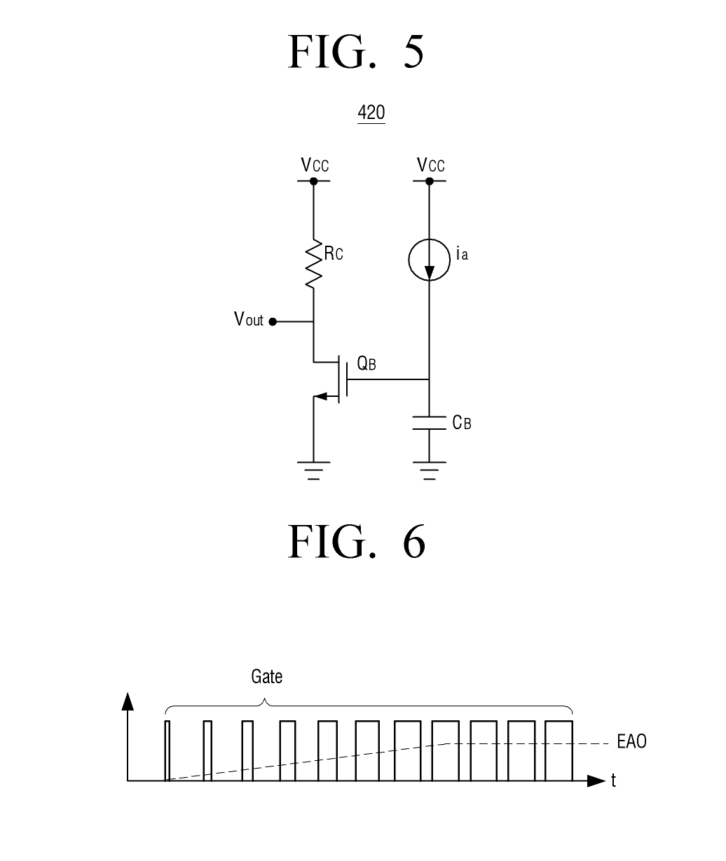

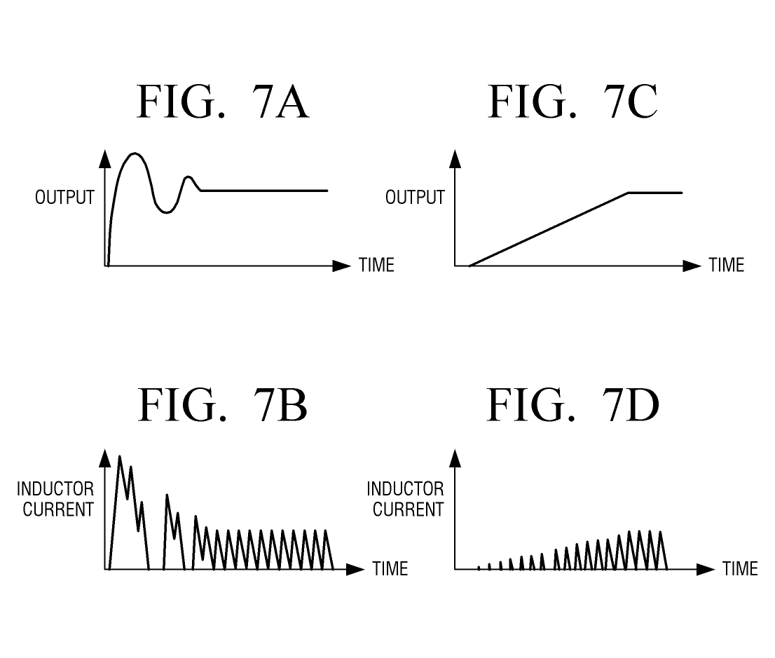

FIG. 4 is a circuit diagram of the controller 300 of FIG. 3 according to an exemplary embodiment. FIG. 5 is a circuit diagram illustrating a soft start block (or part) 420 of FIG. 4. FIG. 6 is a view illustrating soft start operation waveforms. FIGS. 7A through 7D are views illustrating output waveforms in a soft start operation of an exemplary embodiment and output waveforms in a conventional soft start operation.

As shown in FIG. 4, the controller 300 according to the present exemplary embodiment may be referred to as a light-emitting device driving apparatus and may include a modulation signal generator such as a PWM generator 400, a compensator 410, a switching element Qpd, a stabilizer of a resistor R_{B}, and a part or a whole of the soft start block (or a soft start part) 420. Here, the switching element Qpd and the soft start block 420 may be referred to as a transient state determiner. The modulation signal generator, compensator, and transient state determiner may be implemented as a hardware component, software module, or a combination of hardware and software.

Here, the modulation signal generator may include the PWM generator 400, and an output signal of the PWM generator 400, e.g., a PWM control signal, is applied to the gate terminal of the switching element Q_{A} of FIG. 3. If the modulation signal generator adjusts pulse widths of pulses in all sections according to a comparison result provided from the compensator 410, the transient state determiner adjusts a pulse width in a particular section in which a transient state occurs to output a signal.

For example, the modulation signal generator may adjust pulse widths of pulses corresponding only to initial driving of the image display apparatus according to a determination result of the transient state determiner or may adjust pulse widths of pulses corresponding to a section in which a unit frame image continuously maintains the same brightness. Here, the pulse widths may be adjusted so that pulses of a corresponding section have different pulse widths. In more detail, the pulse widths may linearly increase as time t elapses.

The resistor R_{B} forming the stabilizer is connected between the modulation signal generator and the compensator. Here, the resistor R_{B} may operate to stably provide the comparison result output from the compensator 410 to the PWM generator 400.

A drain terminal of the switching element Qpd forming the transient state determiner is commonly connected to an input terminal of the PWM generator 400 into which the comparison result is input and a terminal of the resistor R_{B}. A gate terminal of the switching element Qpd is connected to an output terminal of the soft start block 420, and a source terminal of the switching element Qpd is grounded. Therefore, the switching element Qpd is first turned off according to an output signal of the soft start block 420 and then turned on so that the PWM generator 400 differently forms pulse widths of pulses of a particular section.

According to an exemplary embodiment, the soft start block 420 may receive a power supply voltage Vcc from an external source, e.g., the power supply voltage generator 240 of FIG. 2, to generate a control signal whose voltage level linearly decreases and provide the control signal to the switching element Qpd to control the switching element Qpd. In other words, the soft start block 420 receives the power supply voltage Vcc provided in initial driving of the system as a transient state signal and thus synchronizes with a corresponding time to adjust a characteristic of a signal corresponding to a section at a predetermined time.

As shown in FIG. 5, the soft start block 420 includes a resistor Rc, a switching element Q_{B}, a current source ia, a capacitor C_{B}, etc. Functions of the resistor Rc, the switching element Q_{B}, the current source ia, and the capacitor C_{B} will now be described. If a power supply voltage Vcc is applied from an external source, the current source ia outputs a current to the capacitor C_{B} to charge the capacitor C_{B}. As the capacitor C_{B} is gradually charged, the switching element Q_{B} is slowly turned on. Here, an output signal may be provided to the switching element Qpd of FIG. 4.

According to the above-described structure and operation, in an exemplary embodiment, pulses of a section in which a transient state occurs have different pulse widths as shown in FIG. 4. Also, after a predetermined time elapses, pulses of all sections have the same pulse width.

When comparing signal waveforms shown in FIGS. 7C and 7D according to the exemplary embodiments with conventional signal waveforms shown in FIGS. 7A and 7B, waveforms in transient states are different from one another. In other words, a transient state occurring in a conventional technology may be reduced in the present general inventive concept.

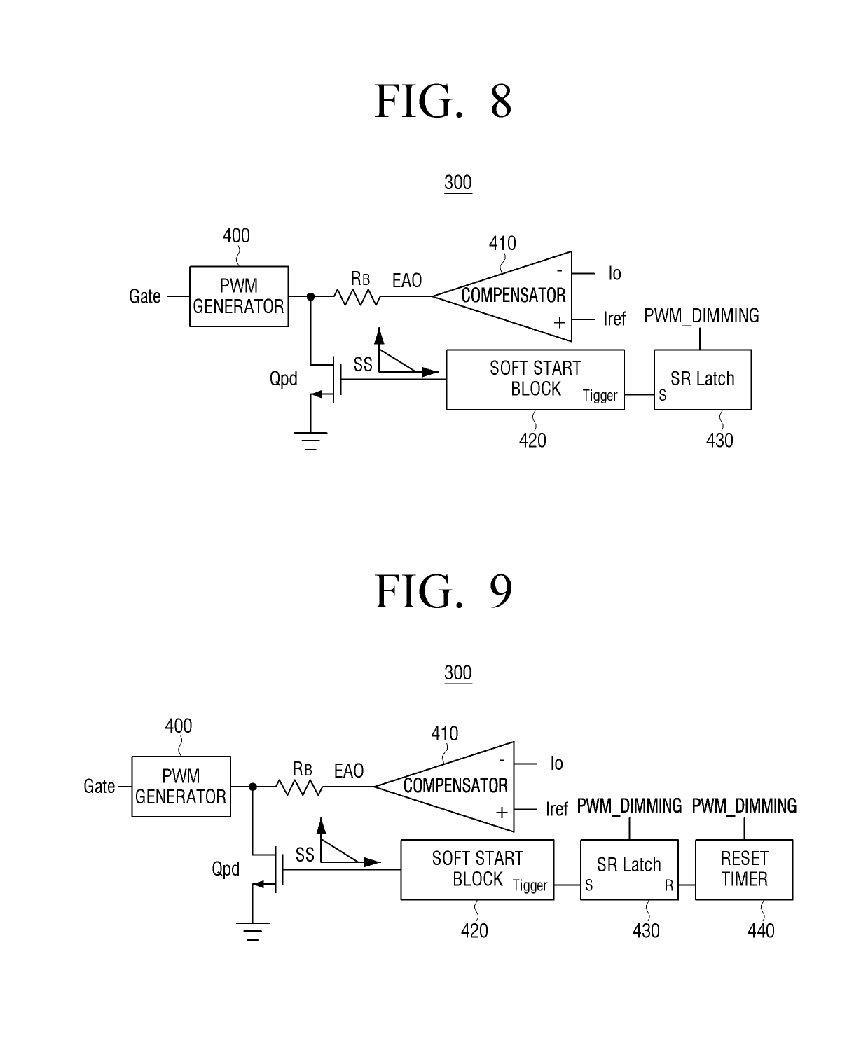

FIG. 8 is a circuit diagram of the controller 300 of FIG. 3 according to another exemplary embodiment.

Referring to FIG. 8 along with FIGS. 3 and 4, the controller 300 according to the present exemplary embodiment, i.e., a light-emitting device driving apparatus, includes a modulation signal generator, a stabilizer, a compensator, a transient state determiner, and a part or a whole of a latch 430.

When compared to the controller 300 of FIG. 4, the modulation signal generator, the stabilizer, the compensator, and the transient state determiner of the controller 300 of the present exemplary embodiment are the same as those of the controller 300 of FIG. 4 and thus will not be described herein.

However, the latch 430 is an SR latch and operates according to a dimming signal first provided from the interface unit 200 of FIG. 2 to provide an output signal to the soft start block 420.

According to the above-described structure, if a backlight is not to be driven until power is applied to the image display apparatus according to the present exemplary embodiment to operate a product, and a preparation for displaying an image on a screen is made, the backlight is controlled to further precisely operate in a transient state. For example, a time required for applying a power source and displaying an image may be several seconds up to dozens of seconds.

FIG. 9 is a circuit diagram of the controller 300 of FIG. 3 according to another exemplary embodiment.

Referring to FIG. 9 along with FIGS. 4 and 8, the controller 300 according to the present exemplary embodiment, i.e., a light-emitting device driving apparatus, includes a modulation signal generator, a stabilizer, a compensator, a transient state determiner, a latch 430, and a part or a whole of a timer 440.

When compared to the controller 300 of FIG. 8, the modulation signal generator, the stabilizer, the compensator, the transient state determiner, and the latch 430 of the controller 300 of the present exemplary embodiment are the same as those of the controller 300 of FIG. 8 and thus will not be described herein.

However, the timer 440 counts a predetermined number of times according to a value preset by a user. In other words, if the timer 440 is set to repeatedly count 5 times, the timer 440 counts from 0 to 5 with respect to an input pulse and then returns to 0. As described above, the timer 440 according to the present exemplary embodiment receives dimming signals of a plurality of unit frames from the interface unit 200 of FIG. 2 and performs counting whenever the dimming signals are input. If the counted value exceeds a preset value, the timer 440 outputs a signal to reset the latch 430.

According to the above-described structure and driving result, in the present exemplary embodiment, if a backlight is completely turn off for a long time during an operation of a circuit for an image-quality related purpose, an output voltage Vo of a driving circuit is discharged to be lower than or equal to a normal state voltage. Therefore, when a light-emitting device, i.e., an LED, is lit, a transient state, which may occur like when a circuit initially operates, may be reduced.

In other words, if a dimming signal displays an off state for a predetermined time and then displays an on state, a soft start sequence proceeds again to remove an inappropriate transient phenomenon.

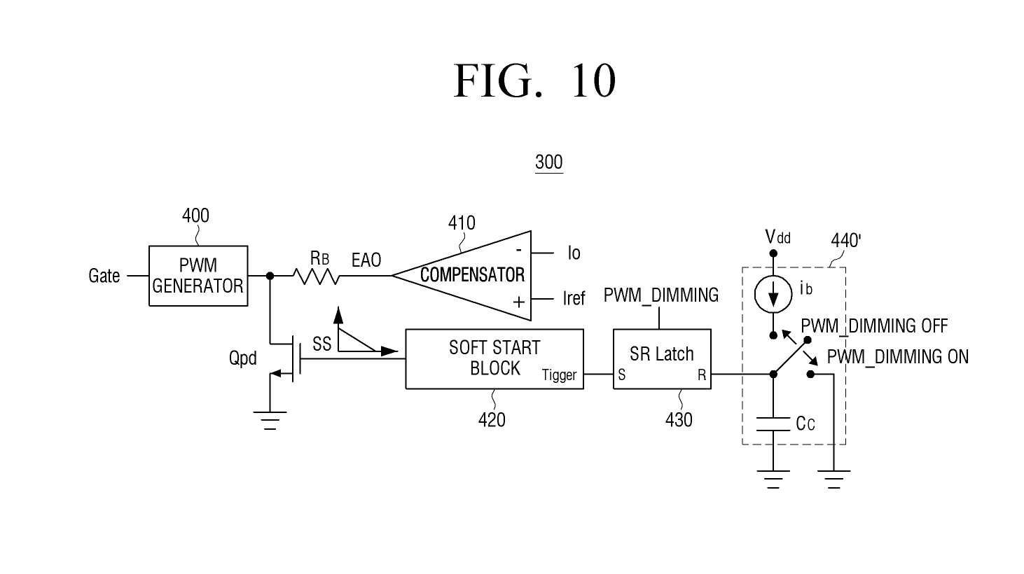

FIG. 10 is a circuit diagram of the controller 300 of FIG. 3 according to another exemplary embodiment.

Referring to FIG. 10 along with FIGS. 3 and 9, the controller 300 of the present exemplary embodiment, i.e., a light-emitting device driving apparatus, includes a modulation signal generator, a stabilizer, a compensator, a transient state determiner, a latch 430, and a part or a whole of a reset driver 440′.

When compared to the controller 300 of FIG. 9, the modulation signal generator, the stabilizer, the compensator, the transient state determiner, and the latch 430 of the controller 300 of the present exemplary embodiment are the same as those of the controller 300 of FIG. 9 and thus will not be described herein.

However, the reset driver 440′ of FIG. 10 performs the same role as the timer 440 of FIG. 9. Although not shown in the drawings, the reset driver 440′ includes a current source unit to which a power supply voltage is applied, a switching unit which is controlled to be turned on/off according to a characteristic of a dimming signal, and a charging unit, e.g., a capacitor Cc, which is connected to the current source unit when a dimming signal DIMMING_OFF is provided from the interface unit 200 of FIG, to charge a current ib, and provides a charged value, i.e., a voltage, to a reset terminal of the latch 430. When the capacitor Cc is full charged, a signal is provided to the reset terminal to reset the latch 430. Therefore, a capacitance of the capacitor Cc may be used to determine whether a light-emitting device of a backlight exceeds a value preset by a user to be turned off

According to the above-described structure and driving result, in the present exemplary embodiment, if a backlight is completely turned off for a long time during driving of a driving circuit for an image-quality related purpose, an output voltage Vo of the driving circuit is discharged to be lower or equal to a normal state voltage. Therefore, when a light-emitting device, i.e., an LED, is lit, a transient state, which may occur like when the driving circuit initially operates, may be reduced.

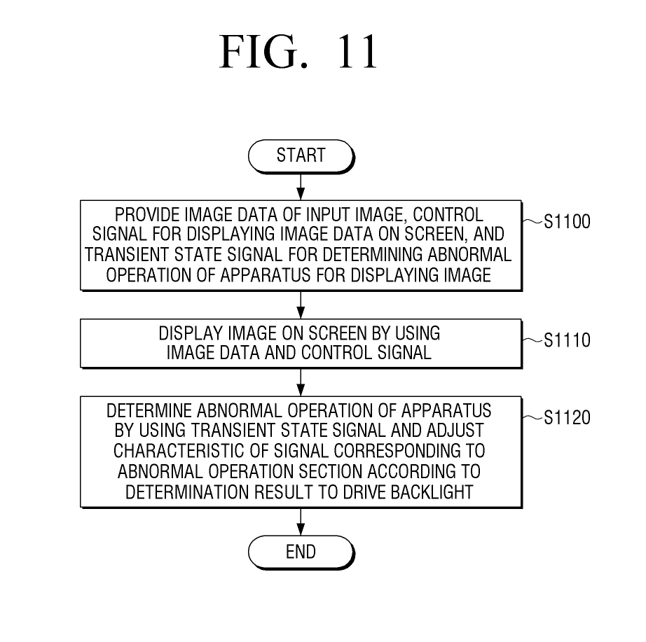

FIG. 11 is a method of displaying an image according to an exemplary embodiment.

For the descriptive convenience, referring to FIG. 11 along with FIG. 1, in operation S1100, an image display apparatus according to the present exemplary embodiment receives an image to generate image data of the image, a control signal for displaying the image data on a screen, and a transient state signal for determining an abnormal operation of the image display apparatus for displaying the image.

In operation S1110, the image display apparatus displays the image on the screen by using the image data and the control signal. Here, the image may be realized in a frame unit on the screen, and the image display apparatus may be driven at 120 Hz or 240 Hz for the realization of the image. The other contents related to the realization of the image have been sufficiently described above and thus will not be described herein.

In operation S1120, the display apparatus determines the abnormal operation thereof by using the transient state signal and adjusts a signal characteristic corresponding to an abnormal operation section according to the determination result to drive a backlight.

For example, the image display apparatus may use a power supply voltage provided during its initial driving as a transient state signal to determine that a transient state occurs in its initial driving. Alternatively, the image display apparatus may determine that a transient state occurs when brightness of a unit frame image, e.g., a dim state, continues to generate a dimming signal and use the dimming signal as a transient state signal. As described above, the image display apparatus adjusts a characteristic of a signal corresponding to initial driving of the image display apparatus or a section in which a dim state of a unit frame image continues in order to drive a backlight.

For example, if a light-emitting device such as an LED of a backlight is PWM-controlled, the image display apparatus adjusts pulse widths of pulses corresponding to a transient state section to be different from one another. Here, each of the pulse widths may linearly increase with respect to time t.

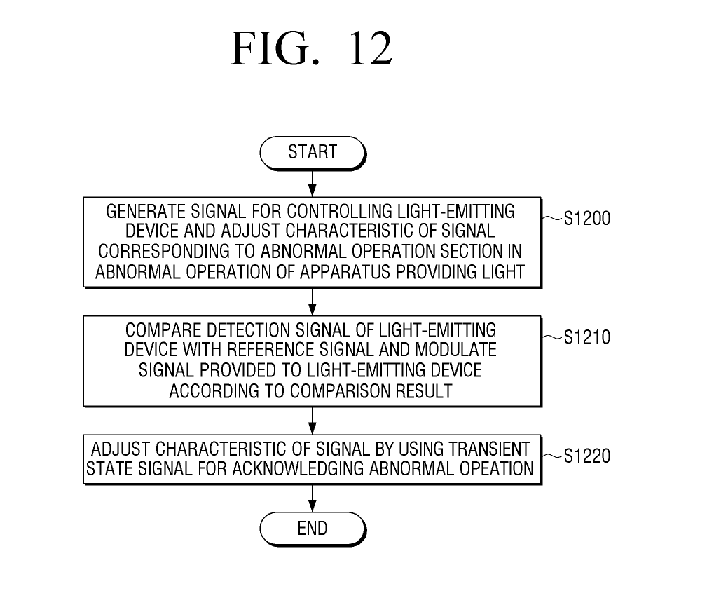

FIG. 12 is a flowchart illustrating a method of driving a light-emitting device according to an exemplary embodiment.

For the descriptive convenience, referring to FIG. 12 along with FIGS. 4 and 8 through 10, in operation S1200, a light-emitting device driving apparatus according to the present exemplary embodiment generates a signal for controlling a light-emitting device constituting a backlight of an image display apparatus and adjusts a characteristic of a signal corresponding to an abnormal operation section in an abnormal operation of the image display apparatus.

For example, if the image display apparatus PWM-controls the light-emitting device, the light-emitting device driving apparatus adjusts only pulses corresponding to the abnormal operation section to have different pulse widths. Therefore, the abnormal operation, i.e., a transient state, may be reduced.

In operation S1210, the light-emitting device driving apparatus compares a detection signal of the light-emitting device with a preset reference signal and converts a signal provided to the light-emitting device by using the comparison result. In this process, the light-emitting device is sensitive to a temperature, and thus a current amount of the light-emitting device may be changed, thereby providing non-uniform light. For this purpose, the light-emitting device driving apparatus is provided with feedback on the detection signal and uses the detection signal. Therefore, when the light-emitting device is PWM-controlled, pulse widths of all sections may be modulated.

In operation S1220, the light-emitting device driving apparatus controls a characteristic of the signal to be adjusted by using a transient state signal for acknowledging the abnormal operation of the image display apparatus. Here, the control of the characteristic of the signal to be adjusted is to adjust signals, e.g, pulse signals, to have different pulse widths only in a section in which a transient state occurs. In order to accurately determine the section, the light-emitting device driving apparatus may use a power supply voltage as a transient state signal in initial driving of the image display apparatus or may use a dimming signal indicating brightness information of an input unit frame image. This has been sufficiently described above and thus will not be described herein.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An apparatus for displaying an image, the apparatus comprising:
a transient state information provider configured to generate and output image data of an input image and a timing signal for displaying the image data on a screen, the transient state information provider being further configured to provide a transient state signal in an abnormal operation of a power source and the image input into the apparatus;
a display panel which receives the image data and the timing signal and displays the image on the screen by using the image data and the timing signal; and
a backlight unit (BLU) which generates a control signal for controlling a light-emitting device providing light to the display panel, and the BLU controls the light-emitting device by adjusting a characteristic of the control signal corresponding to an abnormal operation section of the abnormal operation to be changed by using the transient state signal provided from the transient state information provider.

2. The apparatus of claim 1, wherein the transient state information provider comprises:
a power supply voltage generator which provides a power supply voltage as the transient state signal in initial driving of the apparatus.

3. The apparatus of claim 1, wherein the transient state information provider comprises:
a dimming signal generator which generates and provides a dimming signal indicating brightness of a unit frame image as the transient state signal.

4. The apparatus of claim 3, wherein if the dimming signal indicating the brightness of the unit frame image is used, the BLU determines the abnormal operation when brightnesses of a plurality of unit frame images are equally maintained.

5. The apparatus of claim 4, wherein the BLU controls the light-emitting device by using pulse width modulation (PWM) and adjusts pulses in a section in which the brightnesses of the plurality of unit frame images are equally maintained to have different pulse widths in order to adjust the characteristic of the control signal.

6. An apparatus for driving a light-emitting device, the apparatus comprising:
a modulation signal generator configured to generate and output a control signal for controlling the light-emitting device, change a characteristic of the control signal corresponding to an abnormal operation section in an abnormal operation of a power source or an image input into an image display apparatus, and output the changed control signal;
a compensator configured to provide a comparison result which compares a detection signal of the light-emitting device with a reference signal to the modulation signal generator, and compensate the light-emitting device by converting the control signal according to the comparison result; and
a transient state determiner configured to receive a transient state signal for acknowledging the abnormal operation of the image display apparatus and control the modulation signal generator to change the characteristic of the control signal by using the transient state signal.

7. The apparatus of claim 6, further comprising:
a stabilizer which is installed between the modulation signal generator and the compensator, the stabilizer stabilizes the comparison result and provides the stabilized comparison result to the modulation signal generator.

8. The apparatus of claim 6, wherein the transient state determiner comprises:
a switch which is connected between an end of the modulation signal generator to which the comparison result is applied and a ground, and pulls the comparison result to the ground; and
a soft start part which determines the abnormal operation of the image display apparatus by using the transient state signal and changes an impedance characteristic of the switching unit according to a determination result in order to change the characteristic of the control signal.

9. The apparatus of claim 8, wherein the soft start part controls the switching unit so that pulse signals corresponding to the abnormal operation section have different pulse widths, in order to change the characteristic of the control signal.

10. The apparatus of claim 8, wherein the soft start part controls the switching unit by using the power supply voltage provided at an initial driving of the image display apparatus.

11. The apparatus of claim 6, further comprising:
a latch which receives a dimming signal for indicating brightness of a unit frame image input into the image display apparatus as the transient state signal and provides a processing result of the dimming signal to the transient state determiner.

12. The apparatus of claim 11, further comprising:
a timer which counts whether brightnesses of a plurality of unit frame images are equally maintained, by using the transient state signal and, if a counted result exceeds a value, resets the latch.

13. The apparatus of claim 11, further comprising:
a reset driver which, when brightnesses of a plurality of unit frame images are equally maintained and the light-emitting device exceeds a value, resets the latch.

14. The apparatus of claim 13, wherein the reset driver comprises:
a current source unit which is connected to the power supply voltage to perform a role of a current source;
a switch which, when a brightness is in a dim state, is connected to the current source unit, and when the brightness is in other states except the dim state, is grounded; and
a charger which comprises one terminal which is connected to the latch and the switching unit and the other terminal which is grounded, and, when the switch is connected to the current source unit, charges a current provided from the current source unit and outputs the charged value to the latch to perform the resetting.

15. The apparatus of claim 14, wherein the charger comprises a capacitor,
wherein the resetting of the latch is determined based on a capacitance of the capacitor which determines whether the light-emitting device exceeds the value.

16. A method of displaying an image, the method comprising:
generating and outputting image data of an input image and a timing signal for displaying the image data on a screen, and providing at least one from among a transient state signal in an abnormal operation of a power source and the image input into an image display apparatus;
receiving the image data and the timing signal and displaying the image on a screen of a display panel by using the image data and the timing signal; and
generating a control signal for controlling a light-emitting device providing light to the display panel and controlling the light-emitting device by adjusting a characteristic of the control signal corresponding to an abnormal operation section in the abnormal operation to be changed by using the transient state signal.

17. The method of claim 16, wherein a power supply voltage is provided as the transient state signal at an initial driving of the image display apparatus or a dimming signal indicating brightness of a unit frame image is generated and provided.

18. The method of claim 16, wherein the control of the light-emitting device comprises: if the dimming signal indicating the brightness of the unit frame image is used, determining the abnormal operation when brightnesses of a plurality of unit frame images are equally maintained.

19. The method of claim 18, wherein the control of the light-emitting device comprises: controlling the light-emitting device by using Pulse Width Modulation (PWM) and adjusting pulses of a section in which the brightnesses are equally maintained to have different pulse widths in order to adjust the characteristic of the control signal.

20. A method of driving a light-emitting device, the method comprising:
generating and outputting a control signal for controlling the light-emitting device, by a modulation signal generator, and changing and outputting a characteristic of the control signal corresponding to an abnormal operation section in an abnormal operation of a power source or an image input into an image display apparatus;
providing, by a compensator, a comparison result which compares a detection signal of the light-emitting device with a reference signal, to the modulation signal generator, and compensating the light-emitting device by converting the control signal according to the comparison result; and
receiving, by a transient state determiner, a transient state signal for acknowledging the abnormal operation of the image display apparatus, and controlling the characteristic of the control signal to be changed by using the transient state signal.

21. The method of claim 20, further comprising:
stabilizing the comparison result by a stabilizer installed between the modulation signal generator and the compensator, and providing the stabilized comparison result to the modulation signal generator.

22. The method of claim 20, wherein the controlling of the characteristic of the control signal to be changed comprises:
pulling the comparison result to a ground through a switching unit connected between an end of the modulation signal generator to which the comparison result is applied and the ground; and
determining the abnormal operation of the image display apparatus by using the transient state signal and changing a characteristic of an impedance of the switching unit according to a determination result to change the characteristic of the control signal.

23. The method of claim 22, wherein the switching unit is controlled so that pulse signals corresponding to the abnormal operation section have different pulse widths, in order to change the characteristic of the control signal.

24. The method of claim 22, wherein the switching unit is controlled by using a power supply voltage provided at an initial driving of the image display apparatus in order to change the characteristic of the control signal.

25. The method of claim 22, further comprising:
receiving a dimming signal indicating brightness of a unit frame image input into the image display apparatus as the transient state signal through a latch and providing a processing result of the dimming signal to the transient state determiner.

26. The method of claim 25, further comprising:
counting whether brightnesses of a plurality of unit frame images are equally maintained, by using the transient state signal, and if the counting result exceeds a value, resetting the latch.

27. The method of claim 25, further comprising:
if brightnesses of a plurality of unit frame images are equally maintained, and the light-emitting device exceeds a value, resetting the latch.

28. The method of claim 27, wherein the resetting of the latch comprises:
if a brightness is in a dim state, performing a connection to a current source unit to receive a current, and if the brightness is in other states except the dim state, performing grounding; and
if the connection to the current source unit is performed, charging the current provided from the current source unit and providing a charged value to reset the latch.

29. The method of claim 28, wherein the charging is performed by a capacitor, and the resetting is determined based on a capacitance of the capacitor which determines whether the light-emitting device exceeds the value.
